(19) United States
(12) Patent Application Publication
(10) Pub. No.: US 2014/0129374 A1
(43) Pub. Date: May 8, 2014

(54) INTELLIGENT AND INFORMED STORE DESIGN

(71) Applicant: Anantha Pradeep, Piedmont, CA (US)

(72) Inventor: Anantha Pradeep, Piedmont, CA (US)

(21) Appl. No.: 14/023,325

(22) Filed: Sep. 10, 2013

Related U.S. Application Data
(60) Provisional application No. 61/722,361, filed on Nov. 5, 2012.

(51) Int. Cl. G06Q 30/06

(52) U.S. Cl. CPC G06Q 30/0601; G06Q 30/0633
USPC 705/26.7; 705/26.1; 705/26.8

(57) ABSTRACT

Mechanisms are provided for intelligently creating store designs in a neurologically informed manner. A store layout can be set based on time of day and biorhythms, with early morning sections, mid-morning sections, etc. Sub-brands may be provided in each section. Point-of-sale material design and interaction is neurologically enhanced. Store promotions are improved using augmented reality. A smart shopping cart or basket is used to automatically scan items, provide promotions, detect items, and suggest other products as a customer moves throughout the store.

### CROSS-REFERENCE TO RELATED APPLICATIONS

This application claims the benefit under 35 U.S.C. §119(e) of U.S. Provisional Patent Application 61/722,361, entitled: “INTELLIGENT AND INFORMED STORE DESIGN” filed on Nov. 5, 2012 (Attorney Docket No. PRDPP008P), which is incorporated herein by reference in its entirety.

### TECHNICAL FIELD

The present disclosure relates to intelligent and informed store design.

### DESCRIPTION OF RELATED ART

Conventional store design usually involves design teams including architects, interior decorators, industrial designers, graphic designers, ergonomics experts, and marketing professionals. Store designs are typically structured around stocking and selling products to consumers, and spaces are designed to provide a positive shopping experience while encouraging increased purchasing.

A variety of conventional plans are available including the straight plan, pathway plan, diagonal plan, curved plan, varied plan, and geometric plan. A straight plan divides transitional areas between parts of a store by using walls or high shelves to display merchandise. These plans often try to move a customer to the back of the store. This design is often used for a variety of stores such as supermarkets, pharmacies, bookstores, etc.

A pathway plan is suitable for large stores on a single level. A path is unobstructed by shop fixtures and guides a customer through the store. The pathway plan is often used in furniture and department stores. A diagonal plan uses perimeter design to cause angular traffic flow. A diagonal plan is often used in self-service retail. A curved plan aims to create an intimate, soft, and inviting environment that emphasizes the structure of the space, reduces sharp corners, and introduces circular fixtures. This fixture is often found in salons and boutiques. A varied plan draws attention to special focus areas and is suited for footwear stores. Geometric plans use racks and fixtures to create a geometric floor plan and circular movement. Defined retail spaces can be created in certain areas. Geometric plans are often used in sporting goods stores.

Although store design processes are effective in many instances, they are typically not neurologically informed. In many instances, store designs are created and evaluated using focus groups and customers and may even be in some instances neurologically evaluated after production, but the store design itself is conventionally not neurologically informed.

Consequently, techniques and mechanisms of the present invention provide improved mechanisms for generating and customizing store designs.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of system for intelligent in-store design.

FIG. 2 illustrates a particular example of a smart cart.

FIG. 3 illustrates a particular example of a mechanism for presenting in-store advertisements based on time-of-day.

FIG. 4 illustrates a particular example of a mechanism for generating a biorhythm-based in-store design.

FIG. 5 illustrates a particular example of a server.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular types of stores. However, it should be noted that the techniques and mechanisms of the present invention apply to a variety of different types of stores. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

Mechanisms are provided for intelligently creating store designs in a neurologically informed manner. A store layout can be set based on time of day and biorhythms, with early morning sections, mid-morning sections, etc. Sub-brands may be provided in each section. Point of sale material design and interaction is neurologically enhanced. Store promotions are improved using augmented reality. A smart shopping cart or basket is used to automatically scan items, provide promotions, detect items, and suggest other products as a customer moves throughout the store.

### Example Embodiments

Current techniques for store design are limited. In many examples, design teams including architects, interior decorators, industrial designers, graphic designers, ergonomics experts, and marketing professionals focus design around stocking and selling products to customers. A variety of conventional plans are available including the straight plan, pathway plan, diagonal plan, curved plan, varied plan, and geometric plan. In many instances, a store design is based on one or more conventional plans. A straight plan divides transitional areas between parts of a store by using walls or high shelves to display merchandise. A pathway plan provides a walkway guiding a customer through the store. A diagonal plan uses perimeter design to cause angular traffic flow. A curved plan aims to create an intimate, soft, and inviting environment that emphasizes the structure of the space, reduces sharp corners, and introduces circular fixtures. A varied plan draws attention to special focus areas and is suited for footwear stores. A geometric plan uses racks and fixtures to create a geometric floor plan and circular movement.

Although conventional store designs are effective, they are typically not neurologically informed during the design phase. The techniques of the present invention enhance an in-store experience by using a variety of neurologically informed mechanisms.

A conventional retail environment is in fundamental misalignment with the brain. Grocery store designs in particular are misaligned. In particular, the essential food shopping experience does not recognize, nor does it relate to, how the brain functions at the elemental level. According to various embodiments, biorhythm and/or neuro-biorhythm based planograms, shelf designs, and aisle designs are used to enhance an in-store experience. By redesigning the store to more closely match the brain/body's basic systems, the retail experience can be transformed into a much more highly productive one for both the shopper and seller.

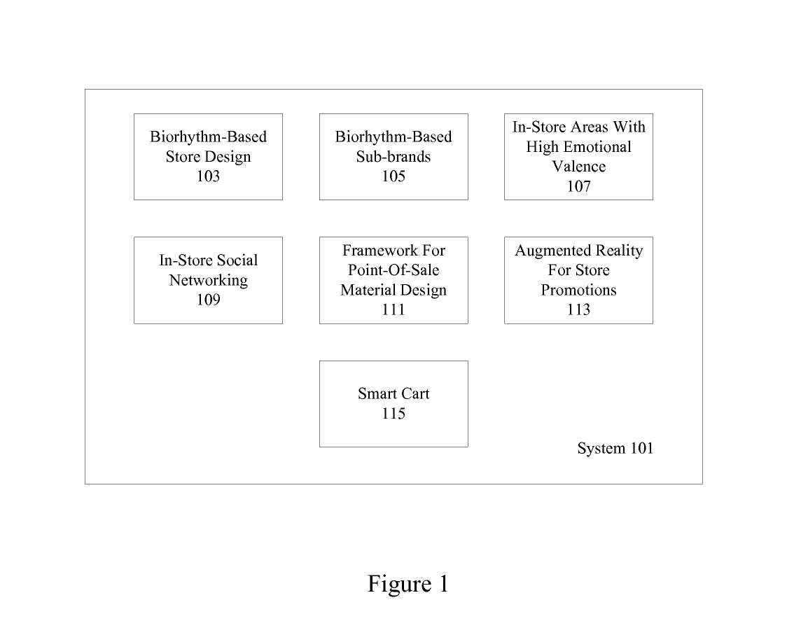

FIG. 1 illustrates a particular example of system for intelligent in-store design. According to the present embodiment, this system 101 includes various aspects that can be integrated into a store design. One or more of these aspects can be used together or in conjunction with traditional store designs to enhance the shopping experience in a more neurologically informed manner.

According to various embodiments of the present invention, biorhythm-based store design 103 can be used as one aspect of system 101. It is generally recognized that the brain looks at things through the lens of time. Accordingly, store design can be arranged temporally so that a store includes an early morning section with products such as coffee and tea, a mid-morning section with products such as light snacks, a lunch section with products such as meals, and so on for various parts of the day. Store aisles, shelves, and displays in each section can be themed to correspond to the particular time of day. In addition, illumination and lighting can be varied based on time of day.

In particular exemplary embodiments, biorhythm-based sub-brands 105 can also be used as an aspect of system 101. By implementing a biorhythm-based store design paradigm, as described above, entirely new opportunities for brand marketers are available. In particular, new sub-brands (or even entirely new brands) that align with the new retail environment can be created. For example, toothpaste can be sub-branded to have morning and night versions, which can differ in one or more characteristics such as appearance, packaging, presentation, colors, textures, and flavors. These sub-brands can then be placed in the morning and evening sections of the store, respectively. In another example, sub-brands for drinks could be selected according caffeine levels or caloric intake levels that are appropriate for the time of day. For instance, highly caffeinated drinks can be located in a morning section and lesser or non-caffeinated drinks can be located in the afternoon and/or evening sections. Packaging and theming of products can be designed to match the ambience for a morning, afternoon, evening, or other temporally designed section. According to various embodiments, new brands and/or sub-brands can be an entirely intuitive extension from the consumers' subconscious perspective. The sub-brands can be perceived as a natural and therefore an essentially welcome fit into their lives. According to various embodiments, music, illumination, and theming of each of the store areas is checked for congruence with a corresponding biorhythm. A congruence score is automatically generated to determine the level of congruence. Music, illumination, and theming can be implemented when a congruence score reaches a particular threshold. A congruence score can be automatically generated or generated with the assistance of survey information.

Another aspect of system 101 that can be used in various embodiments of the present invention includes incorporating areas of high emotional valence 107 into a store to neurologically optimize the store. It is generally recognized that shopping invokes a number of neurological systems and evokes a range of emotions. Emotional valence refers to the emotional attractiveness or aversiveness of an event, experience, presentation, etc. In other words, valence can be used to describe whether an area of a store creates a pleasant or unpleasant experience. One of the neurological ‘barriers’ to consumers' enjoyment and satisfaction in the retail environment is the essential disconnection it has with the natural world. From lighting to product displays and more, the typical experience is distinctly more artificial than natural. By incorporating sensory cues and importing experiences from the natural world into the retail setting, shoppers will feel fundamentally more engaged and more subconsciously ‘at home’. In addition, animals and pets may be incorporated into a store design. Enhancing consumers' emotional interactions inside the retail environment can translate into a fundamentally more involving experience, which in turn can lead to higher sales per-square-foot. By incorporating high emotional valence 107 areas into a store, certain emotional reactions can be elicited, in a fully-coordinated, whole-store approach.

According to various embodiments of the present invention, in-store social networking can be another aspect of system 101. Given the rapidly-increasing level of consumer connectivity with social media platforms through mobile devices and channels, an in-store optimization system can integrate social media into the store environment. The brain's inherent attraction to interpersonal feedback systems and interactions provide the natural neurological ‘bridge’ for this. In particular, community, feedback, and connectivity can be included in store design. For instance, shoppers can have access to online community members through social media platforms and request feedback from these members about a product, a price, whether an item suits them, etc. Furthermore, allowing a shopper to feel connected to others can make a shopper feel like they're among friends during the shopping experience and supported in their purchases. As a side effect, this can help to encourage sales of the particular items discussed, and can even further market the products to the online community members.

In the present exemplary embodiment, another aspect that can be used with system 101 is a framework for point-of-sale (POS) material design 111 using a neuro-experience framework. POS materials can include flyers, recipe cards, FAQ sheets, brochures, displays (showing videos or advertisements, etc.), etc. that can be used to explain or promote a particular product or brand through an educational and/or entertaining approach. These materials can be placed at a POS such as a checkout counter, register, etc. or at the place where the product and/or brand is located at the store in order to encourage selection and purchase of the associated items. For example, a “how-to” sign can be placed near crafting materials to show ways that the products can be used. This “how-to” can encourage shoppers to select and purchase materials described on the sign. According to various embodiments, POS materials play a central role in achieving success within certain elements of the shopper's experience framework, such as by providing education and entertainment about a product or brand. Furthermore, providing POS materials can enhance the experience of the shopper.

According to various embodiments, augmented reality for improving and relaying in-store promotions 113 can also be used with system 101. Augmented reality can include computer-generated sensory input that supplements a shopper's experience with sound, video, graphics, etc. This sensory data can be implemented through a display, glasses, contact lenses, headset/headgear, projection, handheld device, etc. such that the shopper can see a combination of tangible, real items in the store and also the augmented reality provided through one of these display mechanisms. For instance, a shopper can view a shopping aisle through a smartphone and see not only the actual items in the aisle, but also graphics such as cartoon characters, coupons, advertisements, descriptions, etc. that interact with or overlay the physical items on the screen. In some embodiments, a shopper's characteristics can be identified and promotions most suited for presentation to the shopper using augmented reality systems can be selected. The selections can be based on purchase history, user preferences, interests, etc. For instance, if a shopper likes a particular character, this character can be featured in the augmented reality view of an aisle, section, product, etc. An in-store enhancement system can present augmented reality to the shopper to create more impactful in-store promotions and allow manufacturers, marketers, and retailers to reach consumers in more effective ways.

In particular embodiments, each store area may include very rudimentary designs which can be used as a base to overlay more sophisticated designs provide by an augmented reality system. For example, store shelves may actually include rather plain labels, but the augmented reality system can overlay theming appropriate for a design or a particular selected biorhythm.

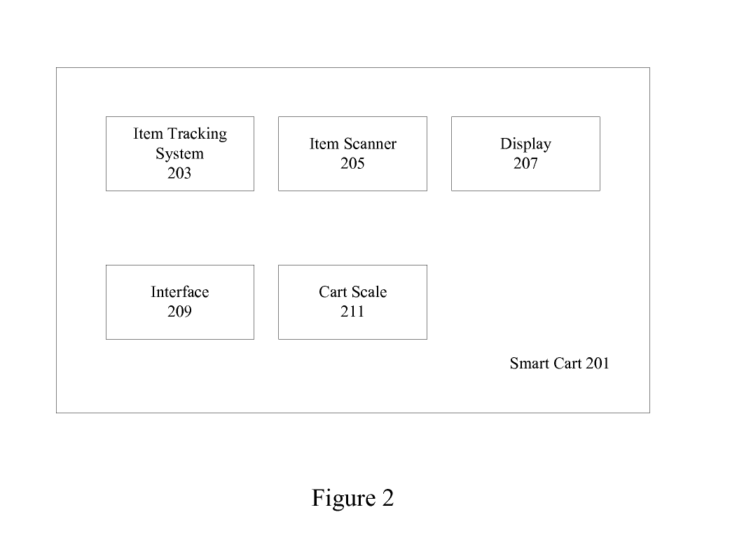

In the present exemplary embodiment, another aspect of system 101 is implementation of smart cart 115 technology. As discussed in more detail below with regard to FIG. 2, smart cart 115 technology can be used to enhance a shopper's experience and make store operations more efficient and profitable. Furthermore, smart cart 115 technology can be implemented to make the retail experience more seamless and satisfying to a shopper's subconscious.

FIG. 2 illustrates a particular example of a smart cart. According to various embodiments, the process of traversing a store can be improved with the use of smart cart technology. Digital technologies including retail applications like near field communications offer extremely significant new advances that can improve the shopping experience for consumers, and render store operations much more efficient and therefore profitable.

With reference to FIG. 2, a smart cart 201 includes item tracking system 203, item scanner 205, display 207, interface 209, and cart scale 211. In particular exemplary embodiments, smart cart 201 can automatically scan items with item scanner 205 and detect the weight of the scanned items with cart scale 211. Discrepancies between cart weight and automatically scanned items can be detected. Display 207 can be used to provide promotions, suggest other products, and connect shopping experiences with social networks. Interface 209 can be used to connect the smart cart to a network, mobile network, store network, etc. According to various embodiments, smart cart 201 can include mobile phone technology with scanner capability, store loyalty programs, and other assets to empower consumers and make the retail experience more seamless and satisfying to the subconscious. Item tracking system 203 can be used to account for items placed in the cart, and in some embodiments can also be used to track spending patterns of a shopper.

According to various embodiments, understanding the brain's core subconscious responses to specific stimuli, combined with high technology, translates into the capability to design advanced store loyalty programs that are better aligned with today's shopper and his/her mindset. The ability to design ‘Super Shopper’ systems that recognize and reward consumers in real time will deliver marketplace benefits for marketing and retail clients. In particular exemplary embodiments, advanced store loyalty programs can be integrated into smart cart 201. In one example, an advanced store loyalty program can include identifying the shopper, identifying past purchases and buying patterns, and current items placed in the cart. Based on this information, rewards, coupons, or other incentives can be offered to the shopper in real-time to encourage purchases of particular products.

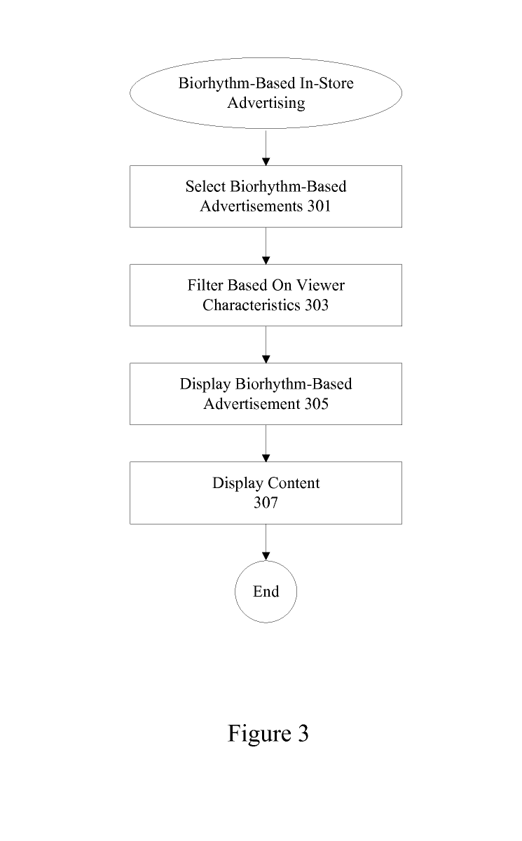

FIG. 3 illustrates a particular example of a mechanism for presenting advertisements in-store based on time of day. It is recognized that the brain is fundamentally and universally driven by specific biological mechanisms. Two of the most critical are the brain/body's reliance on a 24-hour ‘biological clock’, and on a broader basis, perceived changes in the overall environment, such as light and temperature among others. By leveraging these natural rhythms and responses into strategies and creative executions, advertisements can be chosen to compliment the time of day and more effectively promote a brand or product to shoppers.

According to the present exemplary embodiment, biorhythm-based advertisements are selected at 301. These can be advertisements that have features that correspond to the time of day when the advertisement will be displayed. For instance, advertisements to be displayed in the morning may include lighting and settings that are associated with mornings. In another example, the advertisements may feature products or brands that are associated with mornings. Next, at 303, the selected advertisements can be filtered based on viewer characteristics. This may include the demographic of shoppers for a particular time of day, or the day of the week. For instance, if it is found that in the early morning, many shoppers tend to be aged 55+, advertisements aimed at a different age demographic can be removed from the selection. In some exemplary embodiments, the advertisements can be specifically filtered for a particular shopper, such as when the advertisements are displayed on a smart cart screen. Filtering advertisements for a particular shopper may be based on the shopper's preferences, shopping history, demographic, etc.

In the present embodiment, a biorhythm-based advertisement is displayed at 305. The advertisement can take on various forms such as videos, still graphics, motion graphics, text, audio, etc. Once the advertisement is shown, content can be displayed at 307. This content can be an ongoing show, informational programming, additional advertising, etc.

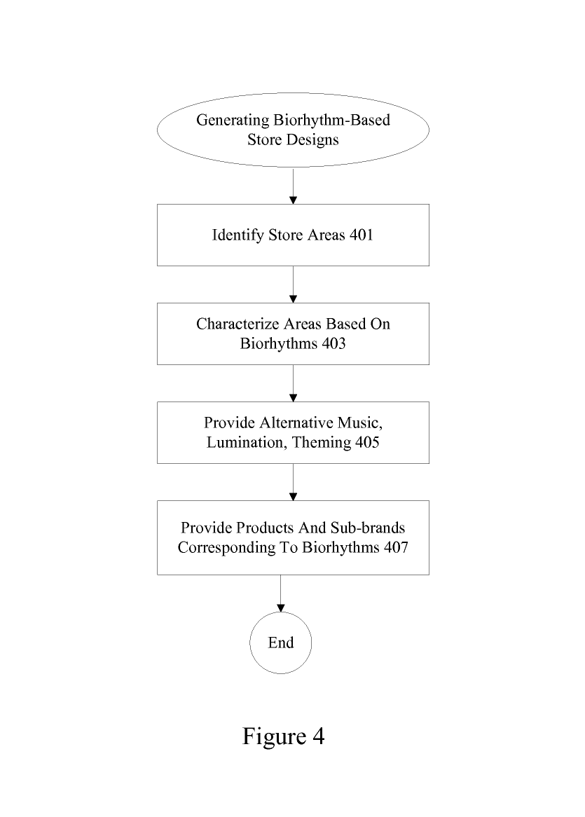

FIG. 4 illustrates a particular example of a mechanism for generating a biorhythm-based store design. In particular exemplary embodiments, it is recognized that the brain looks at things through the lens of time. Accordingly, store design can be arranged temporally so that a store includes an early morning section with coffee and tea, a mid-morning section with light snacks, a lunch section with meals, etc. Store aisles, shelves, and displays can be themed to correspond to particular times of day. Illumination and lighting can be varied based on time of day.

In the present exemplary embodiment, store areas are identified at 401. In particular, locations and boundaries for different sections of the store can be identified. This can vary based on the number of sections desired, the size of the store, layout, etc. Next, these areas can be characterized based on biorhythms at 403. In some embodiments, certain sections of the store can be associated with different parts of the day. For instance, a section on the right side of the store can include morning items, a section on the left side of the store can include late night items, and sections in-between can include items for mid-day, afternoon, and evening, such that as a shopper walks from the right side of the store to the left, products temporally progress from morning to night. Of course, this order could be reversed with morning items on the left side and late night items on the right side in some embodiments. In another example, a morning section can be located at the front of the store and late night items can be located at the back of the store. Any number of configurations for the sections can be used, but generally a natural progression based on biorhythms and time of day would be used to characterize the store areas.

Next, at 405, music, lumination, and theming can be provided for each area at 405. For example, a morning area can include music, lumination, and theming appropriate for this time of day. The music could include calm nature sounds such as birds chirping, or instrumental music that is brisk but not jarring. The lighting could be warm, inviting, sunny, etc. The theming could suggest a fresh start, a new day, etc. Similarly, each area can be designed to naturally flow through the day such that a stroll through the store allows a shopper to feel the changing progression of the day as one store area leads to the next.

In the present exemplary embodiment, products and sub-brands corresponding to biorhythms can be provided at 407. In particular, new sub-brands (or even entirely new brands) are aligned with biorhythms such as time of day. These brands/sub-brands could be an entirely intuitive extension from the consumers' subconscious perspective, such that the sub-brands would be a natural and therefore essentially welcome fit into their lives. For example, toothpaste can be sub-branded to have morning and night versions, which can differ in one or more characteristics such as appearance, packaging, presentation, colors, textures, and flavors. These sub-brands can then be placed in the morning and evening areas of the store, respectively. In another example, sub-brands for drinks could be selected according caffeine levels or caloric intake levels that are appropriate for the time of day. For instance, highly caffeinated drinks can be located in a morning section and lesser or non-caffeinated drinks can be located in the afternoon and/or evening areas. Packaging and theming of products can be designed to match the ambience for a morning, afternoon, evening, or other temporally designed area.

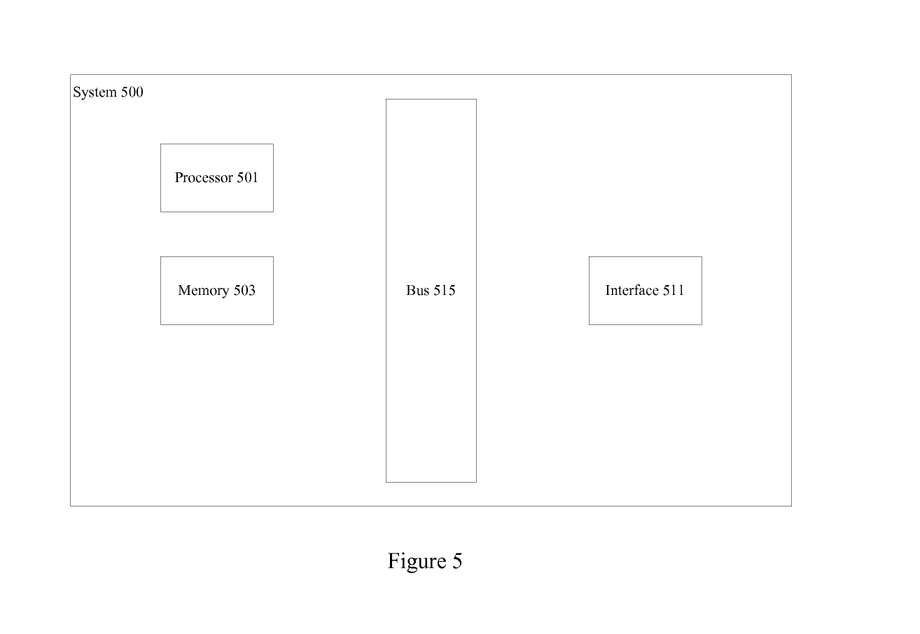

FIG. 5 illustrates a particular example of a server that can be used to implement various aspects of the present invention such as smart carts, advertisements, and store design. A variety of devices and systems can implement particular examples of the present invention. According to particular example embodiments, a system 500 suitable for implementing particular embodiments of the present invention includes a processor 501, a memory 503, an interface 511, and a bus 515 (e.g., a PCI bus). The interface 511 may include separate input and output interfaces, or may be a unified interface supporting both operations. When acting under the control of appropriate software or firmware, the processor 501 is responsible for such tasks such as optimization. Various specially configured devices can also be used in place of a processor 501 or in addition to processor 501. The complete implementation can also be done in custom hardware. The interface 511 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 500 uses memory 503 to store data and program instructions and maintain a local side cache. The program instructions may control the operation of an operating system and/or one or more applications, for example. The memory or memories may also be configured to store received metadata and batch requested metadata.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
generating a plurality of store areas corresponding to biorhythms for a store layout, the biorhythms corresponding to different time of day, the plurality of store areas comprising a morning area, an afternoon area, and an evening area;
selecting different music, illumination, and theming for each of the plurality of store areas, wherein the music, illumination, and theming for each of the plurality of store areas is congruent with the corresponding biorhythm;
verifying the congruence to the corresponding biorhythm of the music, illumination, and theming of each of the plurality of store areas by generating a congruence score by using a processor; and
committing the music, illumination, and theming of each of the plurality of store areas when the congruence score exceeds a particular threshold.

2. The method of claim 1, implementing the music, illumination, and theming of each of the plurality of store areas by using augmented reality headsets, wherein the music, illumination, and theming of each of the plurality of store areas is overlayed through the augmented reality headsets.

3. The method of claim 2, wherein the augmented reality headsets comprise transceivers, processors, and displays.

4. The method of claim 1, wherein a high emotional valence area is introduced into one of the plurality of store areas, wherein the high emotional valence area includes sensory cues to enhance the emotional attractiveness of a shopping experience.

5. The method of claim 4, implementing the high valence area by using augmented reality headsets.

6. The method of claim 1, wherein the plurality of stores areas is perused by using a smart cart.

7. The method of claim 6, wherein the smart cart comprises an item scanner configured to detect the placement of a first item in the cart.

8. The method of claim 6, wherein the smart cart comprises a cart scale configured to detect the weight of the first item, wherein the weight can be used to verify that the first item was properly placed in the cart.

9. The method of claim 6, wherein the smart cart comprises an item tracking system configured to account for a plurality of items placed in the cart.

10. The method of claim 6, wherein the smart cart comprises an interface configured to provide a connection to a network.

11. The method of claim 6, wherein the smart cart provides recommendations for a plurality of items through a cart display, wherein the recommendations are based on detection of the first item.

12. The method of claim 6, wherein the smart cart provides rewards based on shopping history.

13. A system comprising:
an interface configured to receive a request to generate a store layout;
a processor configured to generate a plurality of store areas corresponding to biorhythms for the store layout, the biorhythms corresponding to different time of day, the plurality of store areas comprising a morning area, an afternoon area, and an evening area, the processor further configured to select different music, illumination, and theming for each of the plurality of store areas, wherein the music illumination and theming for each of the plurality of store areas is congruent with the corresponding biorhythm, wherein the congruence to the corresponding biorhythm of the music, illumination, and theming of each of the plurality of store areas is verified by generating a congruence score by using a processor; and
memory configured to maintain the selected music, illumination, and theming of each of the plurality of store areas when the congruence score exceeds a particular threshold.

14. The system of claim 13, wherein the music, illumination, and theming of each of the plurality of store areas is implemented by using augmented reality headsets, wherein the music, illumination, and theming of each of the plurality of store areas is overlayed through the augmented reality headsets.

15. The system of claim 14, wherein the augmented reality headsets comprise transceivers, processors, and displays.

16. The system of claim 13, wherein a high emotional valence area is introduced into one of the plurality of store areas, wherein the high emotional valence area includes sensory cues to enhance the emotional attractiveness of a shopping experience.

17. The system of claim 16, wherein the high valence area is implemented by using augmented reality headsets.

18. The system of claim 13, wherein the plurality of stores areas is perused by using a smart cart.

19. The system of claim 18, wherein the smart cart comprises an item scanner configured to detect the placement of a first item in the cart.

20. The system of claim 18, wherein the smart cart comprises a cart scale configured to detect the weight of the first item, wherein the weight can be used to verify that the first item was properly placed in the cart.
